(19) United States
(12) Patent Application Publication
(10) Pub. No.: US 2025/0362398 A1
(43) Pub. Date: Nov. 27, 2025

(54) STATE CONTROL APPARATUS OF LASER RADAR, AND LASER RADAR AND CONTROL METHOD THEREFOR

(71) Applicant: Windsurf Technology (Wuxi) Ltd., Wuxi City (CN)

(72) Inventors: Jun ZHOU, Suzhou (CN); Xuezhe ZHENG, Suzhou (CN); Yinchao DU, Suzhou (CN)

(21) Appl. No.: 19/291,620

(22) Filed: Aug. 6, 2025

Related U.S. Application Data
(63) Continuation of application No. PCT/CN2023/133974, filed on Nov. 24, 2023.

(30) Foreign Application Priority Data
Feb. 10, 2023 (CN) 202310095848.6

(51) Int. Cl. G01S 7/497

(52) U.S. Cl. CPC G01S 7/497

(57) ABSTRACT

A state control apparatus for a laser radar includes a pre-storage module, a state determination module and a state control module. The pre-storage module is used for storing state information of functional modules. The state determination module is connected to the pre-storage module and is used for acquiring feedback signals of the functional modules in real time and comparing the acquired feedback signals of the functional modules with the state information, so as to determine operating states of the functional modules in the laser radar. The state control module is connected to the state determination module, and is used for adjusting function parameters of the functional modules in the laser radar according to the operating states determined by the state determination module. The operating states of all functional modules are detected, and the functional modules are adjusted or controlled in a timely manner.

### CROSS-REFERENCE TO RELATED PATENT APPLICATION

This application is a continuation application of International Patent Application Ser. No. PCT/CN2023/133974, filed on Nov. 24, 2023, which claims the priority of the China Patent Application No. 202310095848.6, filed on Feb. 10, 2023. The entirety of each of the above patent applications is hereby incorporated by reference herein and made a part of this specification.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a technology filed of a laser radar, and more particularly to a state control apparatus, and a laser radar and a control method therefor.

### BACKGROUND OF THE DISCLOSURE

A laser radar apparatus generally includes a plurality of functional modules having different functions for controlling a state and performance of a laser radar. At the same time, in order to make the laser radar meet safety standards, each of the plurality of functional modules must be monitored inside the laser radar apparatus.

In the laser radar apparatus, monitoring of each of the plurality of functional modules is currently realized by some independent monitoring circuit modules distributed in a system. However, these monitoring circuit modules occupy a large space in the system and cannot monitor all of the plurality of functional modules.

In addition, when an abnormality occurs in each of the plurality of functional modules of the laser radar, each of the plurality of functional modules cannot be instantly adjusted or controlled, which results in decrease in reliability and stability of the laser radar apparatus.

### SUMMARY OF THE DISCLOSURE

Based on the above technical problems, it is necessary to provide a state control apparatus of a laser radar, and a laser radar and a control method of the laser radar for detecting operating states of a plurality of functional modules in a laser radar apparatus and instantly adjusting or controlling each of the plurality of functional modules.

In a first aspect, the present disclosure provides the state control apparatus of the laser radar, where the laser radar includes the plurality of functional modules for maintaining an operation of the laser radar; the state control apparatus of the laser radar including:
a pre-storage module configured to store state information of the plurality of functional modules;
a state determination module connected to the pre-storage module, configured to instantly acquire feedback signals of the plurality of functional modules, and configured to compare the feedback signals of the plurality of functional modules with the state information for determining operating states of the plurality of functional modules in the laser radar; and
a state control module connected to the state determination module, where the state control module is configured to adjust a function parameter of each of the plurality of functional modules in the laser radar according to the operating states determined by the state determination module, and the function parameter includes a high voltage value, output optical power, an emission mode, a temperature control parameter, a scanning speed, a scanning phase or any combination thereof.

In one embodiment, when the state determination module determines that the operating states of the plurality of functional modules are abnormal operating states, the state control module is further configured to determine error types corresponding to the abnormal operating states, determine adjustment information and/or enable control information according to the error types, and control the functional modules to adjust the function parameters according to the adjustment information or control the plurality of functional modules to stop operating according to the enable control information.

In one embodiment, when the plurality of functional modules each having the function parameter that is adjusted according to the adjustment information are maintained in the abnormal operating states, the state control module is further configured to output the enable control information and control the plurality of functional modules to stop operating according to the enable control information.

In one embodiment, the state control apparatus of the laser radar further includes:
a state and error type register module connected to the state determination module, configured to temporarily store the operating state of each of the plurality of functional modules, and configured to temporarily store the error type corresponding to the operating state when the operating state is the abnormal operating state.

In one embodiment, the state control module includes:
a feedback adjustment and fault control module connected to the state and error type register module, and configured to generate the adjustment information and/or the enable control information according to the operating states of the plurality of functional modules;
a digital signal output port connected to the feedback adjustment and fault control module, and configured to output a digital signal including the adjustment information and the enable control information; and
an analog signal output port connected to the feedback adjustment and fault control module, and configured to output an analog signal including the adjustment information.

In one embodiment, the state control apparatus of the laser radar further includes a communication interface connected to the pre-storage module, the state and error type register module and the feedback adjustment and fault control module;

the feedback adjustment and fault control module is further configured to receive the adjustment information and/or the enable control information through the communication interface;

the state and error type register module is further configured to output operating state information of the plurality of functional modules through the communication interface, and configured to output the error types corresponding to the abnormal operating states when the functional modules are in the abnormal operating states.

In one embodiment, the state determination module includes an analog signal processing module, a digital signal processing module and a state determining logic module;

the analog signal processing module includes an analog selector and an analog-to-digital converter; the analog selector is connected respectively to the plurality of functional modules and the analog-to-digital converter, and configured to acquire and transmit an analog feedback signal inputted by each of the plurality of functional modules to the analog-to-digital converter; the analog-to-digital converter is connected to the state determining logic module, and configured to convert the analog feedback signal into a digital signal and transmit the digital signal to the state determining logic module;

the digital signal processing module is connected respectively to the plurality of functional modules and the state determination logic module, and configured to acquire a digital feedback signal inputted by each of the plurality of functional modules and transmit the digital feedback signal to the state determining logic module;

the state determining logic module is connected respectively to the state and error type register module and the pre-storage module, configured to compare the digital signal and/or the digital feedback signal of each of the plurality of functional modules with the state information to obtain a comparison result, configured to determine that the operating state is a normal operating state when the comparison result is consistency, and configured to determine that the operating state is the abnormal operating state when the comparison result is inconsistency.

In one embodiment, the state determination module further includes a temperature sensor connected to the state determining logic module.

In one embodiment, the state control apparatus of the laser radar is a monolithic integrated chip.

In a second aspect, the present disclosure further provides a laser radar. The laser radar includes: a plurality of functional modules that at least include a laser transmitter, a plurality of power supply modules in the laser radar, a receiver, a heating module, a scanning module and a sensor; and

the state control apparatus of the laser radar in any of the above embodiments.

In a third aspect, the present disclosure further provides a control method for the laser radar, which is applied to the state control apparatus of the laser radar or the laser radar in any one of the above embodiments, the control method including:
acquiring a feedback signal and state information of each of the plurality of functional modules in the laser radar;
comparing the feedback signal with the state information of each of the plurality of functional modules for determining an operating state of each of the plurality of functional modules in the laser radar; and
adjusting the function parameter of each of the plurality of functional modules according to the operating state of each of the plurality of functional modules, where the function parameter includes a high voltage value, output optical power, an emission mode, a temperature control parameter, a scanning speed, a scanning phase or any combination thereof.

In the above embodiments, in order to meet a monitoring requirement of the laser radar on each of the plurality of functional modules, the state determination module is connected to the plurality of functional modules in the laser radar and configured to obtain the feedback signal of each of the plurality of functional modules in real time. Then, the state determination module is connected to the pre-storage module, configured to acquire the state information of the plurality of functional modules from the pre-storage module, and configured to compare the feedback signals with the state information to determine the operating state of each of the plurality of functional modules in the laser radar for determining whether or not an abnormality occurs in each of the plurality of functional modules. The state control module is connected to each of the plurality of functional modules in the laser radar and the state determination module. When the state determination module determines the operating states of the plurality of functional modules, the state determination module may, according to operating states that are different from each other, output corresponding state adjustment information for adjusting the function parameter of each of the plurality of functional modules. The operating state is determined in real time such that the state control module is able to output the state adjustment information for adjusting or controlling each of the plurality of functional modules in real time when the abnormality occurs in the operating state of the laser radar. As a result, reliability and stability of the laser radar are improved.

### BRIEF DESCRIPTION OF THE DRAWINGS

The described embodiments may be better understood by reference to the following description and the accompanying drawings, in which:

FIG. 1 is a structure schematic block diagram of a state control apparatus of a laser radar according to one embodiment;

FIG. 2 is a structure schematic diagram of a state and error type register module according to one embodiment;

FIG. 3 is a structure schematic diagram of a state control module according to one embodiment;

FIG. 4 is a structure schematic diagram of a communication interface according to one embodiment;

FIG. 5 is a structure schematic diagram of a state determination module according to one embodiment;

FIG. 6 is a structure schematic diagram of a data acquiring module, an analog signal processing module and a temperature sensor according to one embodiment; and

FIG. 7 is a flowchart diagram of a control method for a laser radar according to one embodiment.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

At present, a laser radar equipment generally includes one or more laser transmitting units, one or more receiving units for photoelectric conversion, a scanning drive and angle encoding device, a main control unit, and various power supply modules. A state and performance of the laser radar equipment are directly affected by an operating state of each of a plurality of functional modules. During operation of the laser radar equipment, in order to meet different functional operating states, the operating state of each of the plurality of functional modules must be adjusted, such as adjustment of transmitted laser energy and a pulse repetition frequency, adjustment of a scanning mode of a scanning device, temperature compensation of a bias voltage of the receiving unit, and so on. At the same time, in order to meet corresponding safety standards, each of the modules in the laser radar equipment must be monitored fully. In a current laser radar equipment, monitoring of each of the plurality of functional modules is often implemented by an independent monitoring circuit module unit distributed in a system. However, the independent monitoring circuit module units are relatively large in scale, and the monitoring of the functional modules is not comprehensive enough. Each of the independent monitoring circuit module units does not have an independent communication function, and cannot instantly adjust and control each of the plurality of functional modules in the laser radar equipment.

Therefore, in order to solve the above problems, the present disclosure provides a state control apparatus of a laser radar. As shown in FIG. 1, the state control apparatus 100 of the laser radar may be installed in the laser radar, and the laser radar may include a plurality of functional modules used for maintaining an operation of the laser radar. The state control apparatus 100 of the laser radar includes a pre-storage module 120, a state determination module 140 and a state control module 160.

The pre-storage module 120 is configured to store state information of the plurality of functional modules.

The plurality of functional modules in the laser radar may include a power module, a scanning module, a laser transmitter, a receiver, and so on. The operation of the laser radar is maintained by the plurality of functional modules as described above. The state information usually is state information corresponding to each of the plurality of functional modules being operating normally, such as operating voltage information of the power module, high bias voltage information of the laser transmitter and the receiver, or the scanning speed information of the scanning module, and so on.

Specifically, the pre-storage module 120 may be communicated with a control terminal in a communication connection manner that is wired communication or wireless communication, which is not limited in the present disclosure. The state information of each of the plurality of functional modules may be written into the pre-storage module 120 by the control terminal. The control terminal may be an external host, a host computer or other processing equipment capable of performing read, write and control operations.

In some exemplary embodiments, the pre-storage module 120 may be a storage chip, such as an electrically-erasable programmable read-only memory (EEPROM) or other type of storage chip whose data is not lost after power failure occurs.

The state determination module 140 is connected respectively to the functional modules and the pre-storage module 120, is configured to acquire the feedback signals of the functional modules, and is configured to compare the feedback signals of the functional modules with the state information for determining operating states of the functional modules in the laser radar.

The feedback signal may usually be a signal generated when each of the plurality of functional modules in the laser radar operates, such as an operating voltage, a high bias voltage or a scanning speed. The operating state includes a normal operating state and an abnormal operating state.

Specifically, the state determination module 140 may compare feedback information acquired from each of the plurality of functional modules with the state information to obtain a comparison result. When the comparison result indicates that the feedback information is the same as the state information, the state determination module 140 determines that the operating state of the functional module is the normal operating state. When the comparison result indicates that the feedback information is not the same as the state information, the state determination module 140 determines that the operating state of the functional module is the abnormal operating state. It should be understood that, the feedback information and the state information that are compared as described above are generally of the same type. The type of the feedback information and the state information may include an analog level, digital information or a pulse frequency, and so on. For example, the feedback information of the power module is the operating voltage, and the feedback information of the power module must be comparted with the operating voltage information included in the state information.

The state control module 160 is connected respectively to the state determination module 140 and the functional modules in the laser radar, and is configured to adjust a function parameter of each of the plurality of functional modules according to the operating state determined by the state determination module 140. The function parameter includes a high voltage value, output optical power, an emission mode, a temperature control parameter, the scanning speed, a scanning phase or any combination thereof.

The high voltage value may typically be a high bias voltage value for the laser transmitter and the receiver in the laser radar. The output optical power may generally be power of a laser emitted by the laser transmitter. The emission mode may generally be an emission frequency grouping mode of the laser of the laser transmitter. The temperature control parameter may be a parameter used for adjusting a temperature of a heating module in the laser radar. The heating module may generate heat according to the temperature control parameter for controlling a temperature in the laser radar. The scanning speed and the scanning phase may generally be functional parameters corresponding to the scanning device in the laser radar.

Specifically, the state control module 160 may obtain the operating state of each of the plurality of functional modules determined by the state determination module 140. When the operating states of the functional modules are the normal operating state, the functional parameters of the functional modules generally do not need to be adjusted. When the operating states of the functional modules are the abnormal operating state, the functional parameters of the functional modules generally must be adjusted. Therefore, the state control module 160 may output the state adjustment information corresponding to the abnormal operating state to each of the functional modules in the laser radar. The functional modules being in the abnormal operating state may adjust the function parameters thereof according to the state adjustment information.

In addition, after the function parameter of the function module being in the abnormal operating state is adjusted, the function module is usually changed to the normal operating state, and thus the state determination module 140 determines that the operating state of the functional module is the normal operating state.

In some exemplary embodiments, if the high bias voltage of the laser transmitter is abnormal, the operating state of the laser transmitter may be determined as the abnormal operating state. The high bias voltage can generally be adjusted. Therefore, the state control module 160 may adjust the high voltage value, and input high voltage adjustment information to the laser transmitter in the laser radar until the high bias voltage of the laser transmitter reaches an expected state. The expected state may generally be a value range of the high bias voltage during a normal operation. It should be understood that, by those of ordinary skill in the art, the above-mentioned example is only configured to illustrate adjustment of the high voltage value, and corresponding state adjustment information may be outputted according to actual application conditions for adjusting the functional parameters of each of the plurality of functional modules in the laser radar.

In the state control apparatus of the laser radar described above, in order to meet a monitoring requirement of the laser radar on each of the plurality of functional modules, the state determination module may be connected to each of the plurality of functional modules in the laser radar to obtain the feedback signal of each of the plurality of functional modules in real time. Then, the state determination module is connected to the pre-stored module to obtain the state information in the pre-stored module. The state determination module compares the feedback signal with the state information, and instantly determines the operating state of each of the plurality of functional modules in the laser radar for determining whether an abnormality occurs in each of the plurality of functional modules. The state control module is connected to each of the plurality of functional modules in the laser radar and the state determination module. After the state control module determines the operating state of each of the plurality of functional modules in the laser radar, the state control module can, according to different operating states, output the corresponding state adjustment information for adjusting the functional parameters of each of the plurality of functional modules in the laser radar. When the operating state of the functional model in the laser radar is abnormal, the state control module can instantly output the state adjustment information for adjusting or controlling each of the plurality of functional modules, thereby improving reliability and stability of the laser radar.

In one embodiment, when the state determination module determines that the operating state of the functional module is the abnormal operating state, the state control module 160 is further configured to determine the error type corresponding to the abnormal operating state, determine corresponding adjustment information and/or enable control information according to the error type, and control the functional module to adjust the functional parameter according to the adjustment information or control the functional module to stop operating according to the enable control information.

The enable control information can generally be understood as information for controlling whether the functional module continues to work. The error type can usually be determined based on characteristics of the functional module corresponding thereto. For example, if a voltage of the power module exceeds or is lower than a rated voltage, the operating state of the power module can be determined as the abnormal operating state, and the error type corresponding to the abnormal operating state may also be determined. For another example, if the temperature of any one of the plurality of functional modules in the laser radar is too high and larger than a preset temperature threshold, the operating state of the one of the plurality of functional modules can be determined as the abnormal operating state, and the error type corresponding to the abnormal operating state is determined. The error type may be recorded by an error code, may also be recorded by a string, or may further be recorded by other codes. In some embodiments of the present disclosure, a specific recording manner of the error type is not limited.

Specifically, when the operating state of the functional module is determined as the abnormal operating state as described above, the state control module 160 can further determine the error type corresponding to the abnormal operating state. For example, if the operating state of the power module is the abnormal operating state, the corresponding error type may be a power module abnormality. For another example, if the scanning speed of the scanning module is too high and larger than a preset scanning speed, the corresponding operating state may be the abnormal operating state and the corresponding error type may be a too high scanning speed of the scanning module. Normally, feedback adjustment can be performed on some of the plurality of functional modules in the laser radar. If the functional module is in the abnormal operating state, whether or not the feedback adjustment can be performed on the function module may be determined according to the error type corresponding to the abnormal operating state. If the feedback adjustment can be performed on the function module, the adjustment information may be determined based on the error type. For example, if the error type is the too high scanning speed of the scanning module, the scanning speed of the scanning module can be adjusted based on the adjustment information to reduce the scanning speed to be within a reasonable range. The reasonable range may be set according to different actual requirements and is not limited in the present disclosure. The feedback adjustment usually cannot be performed on others of the plurality of functional modules in the laser radar. If any one of the plurality of functional modules is in the abnormal operating state, the error type may be determined according to the abnormal operating state, and whether or not the feedback adjustment can be performed on the functional module may be determined according to the error type. If the feedback adjustment cannot be performed, the enable control information corresponding to the functional module may be determined, and the functional module may be controlled to stop operating according to the enable control information. For example, if the error type representing that the voltage of the power module exceeds the rated voltage, abnormal power supply is determined. In this abnormal situation, the feedback adjustment generally cannot be performed on the function module. Therefore, the enable control information corresponding to the power module may be directly outputted for stopping the power module from operating, thereby preventing the others of the plurality of functional modules of the laser radar from being affected.

When the operating state of the functional module having the functional parameter that is adjusted according to the adjustment information is still the abnormal operating state, the state control module 160 further outputs the enable control information and controls the functional module to stop operating according to the enable control information.

Specifically, after the functional module adjusts the functional parameter according to the adjustment information, the operating state of the functional module is still the abnormal operating state. Under this condition, it is generally determined that the feedback adjustment cannot be performed on the functional module for changing the functional module to the normal operating state, so the state control module 160 does not need to output the adjustment information again at this time. The state control module 160 may input the enable control information corresponding to the functional module, and control the functional module to stop operating according to the enable control information, thereby preventing the functional module from being affected by an unreasonable operation.

In this embodiment, when the operating state of the functional module is the abnormal operating state, the corresponding adjustment information and/or enable control information can be outputted according to the error type corresponding to the abnormal operating state for ensuring the stability of the laser radar during operation. When the functional parameter of the functional module is adjusted based on the adjustment information, but the functional module still cannot be changed to the normal operating state, the enable control information is outputted for stopping the functional module from operating, thereby preventing the laser radar from being affected and ensuring the reliability of the laser radar.

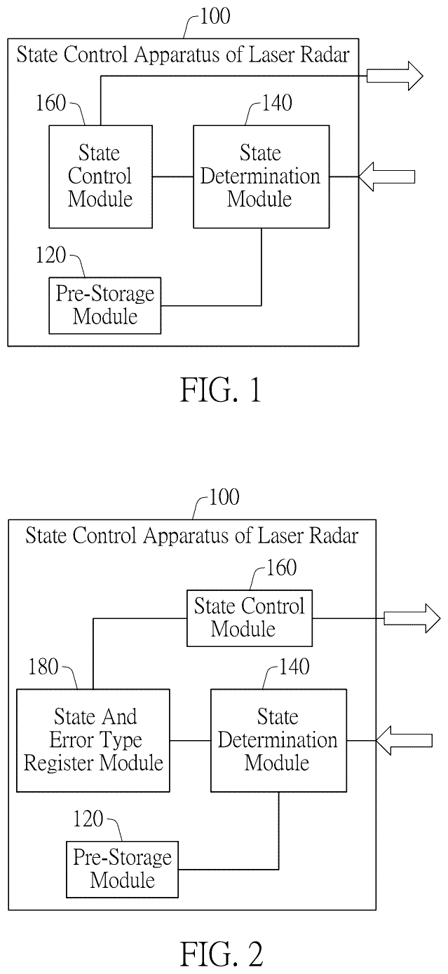

In one embodiment, if the state determination module 140 determines that the operating state of the functional module is the abnormal operating state, as shown in FIG. 2, the state control apparatus 100 of the laser radar further includes a state and error type register module 180 connected to the state judgment module 140. The state and error type register module 180 is configured to temporarily store the operating state of each of the plurality of functional modules, and also temporarily store the error type corresponding to the abnormal operating state when the operating state is the abnormal operating state.

Specifically, each of the plurality of functional modules has a fixed mapping position in the state and error type register module 180. In the state and error type register module 180, the fixed mapping position of each of the plurality of functional modules often stores the operating state corresponding thereto. If the operating state of the functional module is the abnormal operating state, the state and error type register module 180 may also store the error type corresponding to the abnormal operating state. The state and error type register module 180 may further be connected to the state control module 160. The state control module 160 may, from the fixed mapping position of each of the plurality of functional modules in the state and error type register module 180, acquire the operating state corresponding to each of the plurality of functional modules and the error type corresponding to the abnormal operating state.

In this embodiment, the state and error type register module 180 is able to provide the corresponding mapping position to the operating state of each of the plurality of functional modules for ensuring that the operating state of each of the plurality of functional modules is not lost. It is convenient for the state control module 160 to acquire the operating state of each of the plurality of functional modules, improve speed of subsequently adjusting of the functional parameter of each of the plurality of functional modules, and instantly adjust or control each of the plurality of functional modules. In addition, when an external device is connected to the state control apparatus 100 of the laser radar, the external device is able to read information in the state and error type register module 180 for determining the operating states of the functional modules in the laser radar.

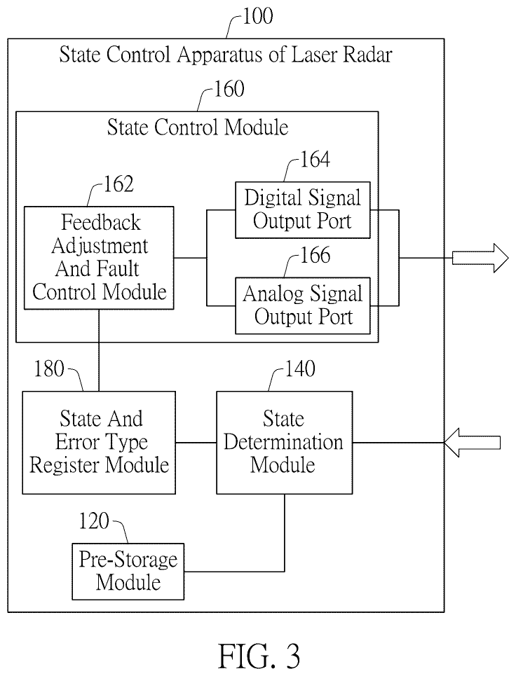

In one embodiment, as shown in FIG. 3, the state control module 160 includes a feedback adjustment and fault control module 162, a digital signal output port 164, and an analog signal output port 166.

The feedback adjustment and fault control module 162 is connected to the state and error type register module 180, and configured to generate the adjustment information and/or the enable control information according to the information in the state and error type register module 180.

The digital signal output port 164 is connected to the feedback adjustment and fault control module 162, and configured to output a digital signal including the adjustment information and the enable control information.

The analog signal output port 166 is connected to the feedback adjustment and fault control module 162, and configured to generate an analog signal including the adjustment information.

Specifically, the feedback adjustment and fault control module 162 acquires the operating state corresponding to each of the plurality of functional modules that is temporarily stored in the state and error type register module 180. When the operating state of the functional module is the abnormal operating state, the feedback adjustment and fault control module 162 further acquires the error type of the abnormal operating state from the state and error type register module 180, and generates the corresponding adjustment information and/or the corresponding enable control information according to the error type. The feedback adjustment and fault control module 162 must be communicated with each of the plurality of functional modules for sending the adjustment information and/or the enable control information to each of the plurality of functional modules. Furthermore, due to the different types of functional modules, the types of adjustment information and/or enable control information may also be different, which may be digital signals or analog signals. Therefore, the state control module 160 includes the digital signal output port 164 and the analog signal output port 166. The digital signal output port 164 and the analog signal output port 166 are respectively connected to corresponding ones of the plurality of functional modules and the feedback adjustment and fault control module 162. The digital signal output port 164 is configured to output a digital signal that includes the adjustment information and the enable control information and is sent by the feedback adjustment and fault control module 162. The analog signal output port 166 is configured to output an analog signal that includes the adjustment information and is sent by the feedback adjustment and fault control module 162. The enable control information is often 0 or 1 and thus included in the digital signal.

In this embodiment, the adjustment information and the enable control information that correspond to the different types of the functional modules are outputted through different signal output ports. Therefore, each of the plurality of functional modules in the laser radar is able to be adjusted or controlled more comprehensively, thereby improving the stability of the laser radar during operation.

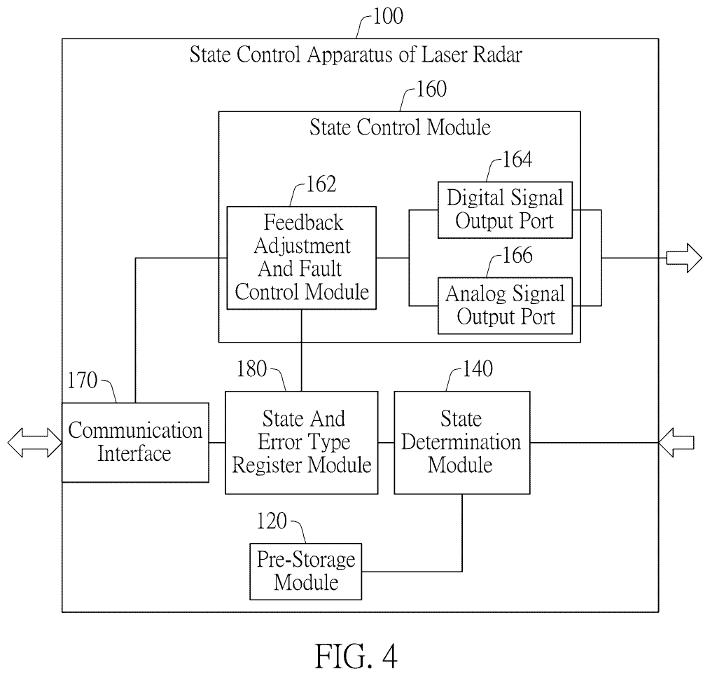

In one embodiment, as shown in FIG. 4, the state control apparatus 100 of the laser radar further includes a communication interface 170. The communication interface 170 is connected to the pre-storage module 120, the state and error type register module 180 and the feedback adjustment and fault control module 162. The feedback adjustment and fault control module 162 is further configured to receive the adjustment information and/or the enable control information through the communication interface 170. The state and error type register module 180 is further configured to output operating state information of the functional modules through the communication interface 170. When the functional modules are in the abnormal operating state, the state and error type register module outputs the error type corresponding to the abnormal operating state.

Specifically, the communication interface 170 usually can also be connected to a control terminal. The control terminal may be an external host, a host computer or other processing equipment being capable of performing read, write and control operations. It should be understood that, the control terminal is an apparatus outside the laser radar and is not included in the laser radar. The control terminal may transmit the state information to the pre-storage module through the communication interface 170. The control terminal may also transmit the adjustment information and/or the enable control information to the feedback adjustment and fault control module 162 through the communication interface 170 for controlling the feedback adjustment and fault control module 162 to adjust the operating state of each of the plurality of functional modules. The state and error type register module 180 may also output the current operating state information of each of the plurality of functional modules through the communication interface 170. When the functional modules are in the abnormal operating state, the state and error type register module 180 may further output the error type to the control terminal through the communication interface 170.

In this embodiment, the communication interface 170 is used to realize interactive control on the state control apparatus 100 of the laser radar by the external control terminal, and realize a communication function of the state control apparatus 100 of the laser radar with the external control terminal. The operating state of each of the plurality of functional modules is adjusted by the control terminal for debugging or repairing the laser radar.

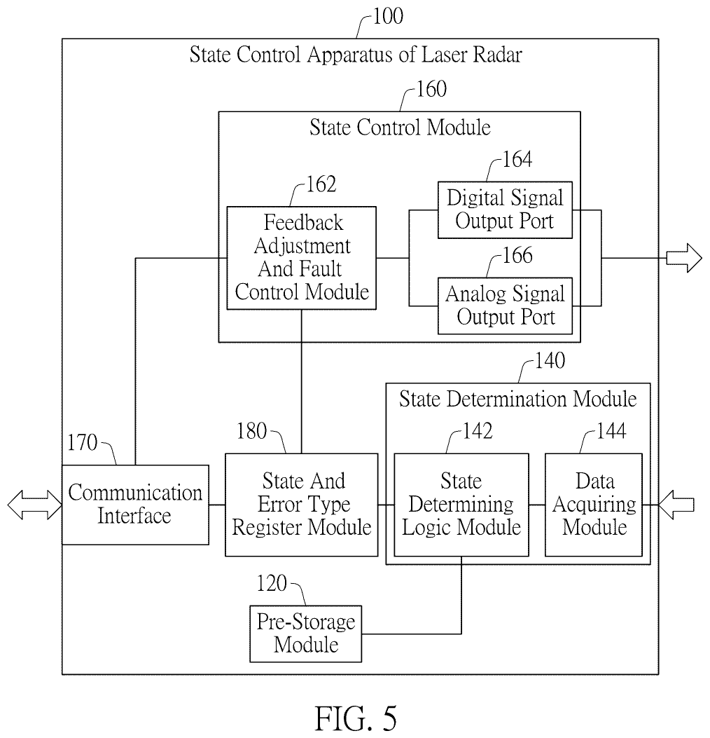

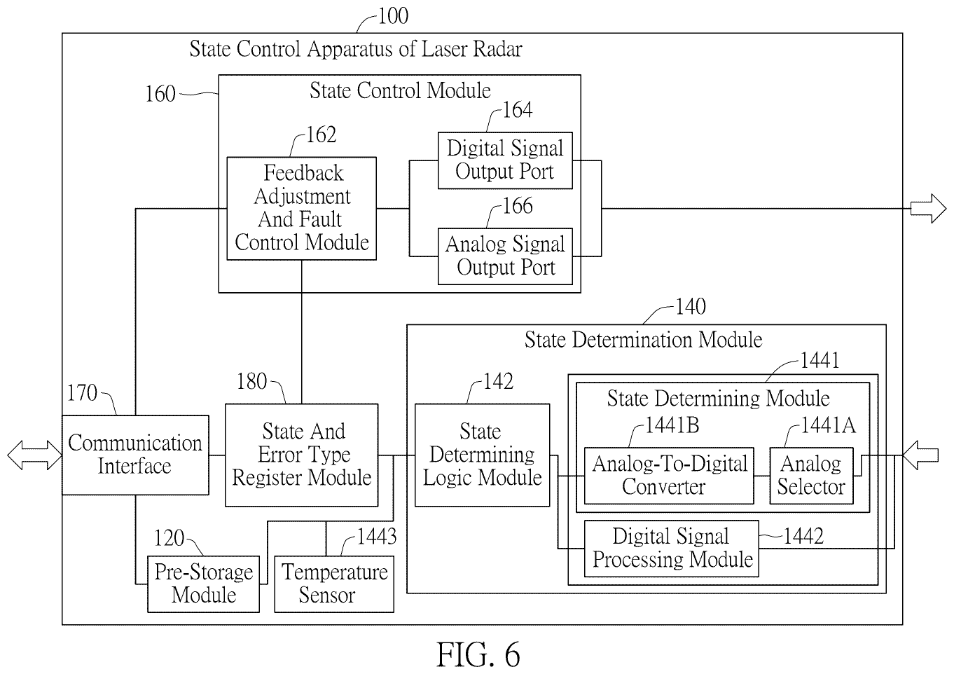

In one embodiment, as shown in FIG. 5, the state determination module 140 includes a data acquiring module 144. The data acquiring module 144 is connected to each of the plurality of functional modules in the laser radar, and configured to acquire the feedback signal of each of the plurality of functional modules. Further, as shown in FIG. 6, the data acquiring module 144 includes an analog signal processing module 1441, a digital signal processing module 1442 and a temperature sensor 1443. The analog signal processing module 1441 includes an analog selector 1441A and an analog-to-digital converter 1441B; the analog selector 1441A is connected respectively to each of the plurality of functional modules and the analog-to-digital converter 1441B, and configured to acquire an analog feedback signal inputted by each of the plurality of functional modules and transmitting the analog feedback signal to the analog-to-digital converter 1441B; the analog-to-digital converter 1441B is connected to the state determining logic module 142, and configured to convert the analog feedback signal into the digital signal and transmitting the digital signal to the state determining logic module 142; the digital signal processing module 1442 is connected to the each of the plurality of functional modules and the state determining logic module 142, and configured to acquire a digital feedback signal inputted by each of the plurality of functional modules and transmitting the digital feedback signal to the state determining logic module 142. The analog-to-digital converter 1441B may generally be an A/D converter or may also be referred to as an analog to digital converter (ADC). The state determining logic module 142 is connected respectively to the state and error type register module 180 and the pre-storage module 120, and configured to compare the digital signal and/or the digital feedback signal of each of the plurality of functional modules with the state information to obtain the comparison result. When the comparison result is consistency, the state determining logic module 142 determines that the operating state is the normal operating state. When the comparison result is inconsistency, the state determining logic module 142 determines that the operating state is the abnormal operating state.

Specifically, the state determination module 140 may include the data acquiring module 144. The data acquiring module 144 usually can be connected to each of the plurality of functional modules in the laser radar, and acquire the feedback signal from each of the plurality of functional modules, such as a feedback signal from the laser transmitter, a feedback signal from the receiver, a feedback signal from a temperature sensor, a feedback signal from the scanning device and so on. Further, the different types of the functional modules are often in the laser radar. The different types of the functional modules respectively send different types of the feedback signals. Correspondingly, the data acquiring module 144 also must have corresponding modules configured to acquire the different types of feedback signals. Therefore, the data acquiring module 144 may include the analog signal processing module 1441 and the digital signal processing module 1442. The analog signal processing module 1441 may include the analog selector 1441A and the analog-to-digital converter 1441B. The analog selector 1441A is connected to an analog channel corresponding to each of the plurality of functional modules in the laser radar. The analog selector 1441A may also be connected to the analog-to-digital converter 1441B. A multi-channel analog feedback signal outputted by each of the plurality of functional modules in the laser radar is transmitted to the analog-to-digital converter 1441B through the analog gate 1441A. Typically, data processed by the state determining logic module 142 is a digital signal. Therefore, the state determining logic module 142 must be connected to the analog-to-digital converter 1441B. The analog-to-digital converter 1441B converts the analog feedback signal into the digital signal and transmits the digital signal to the state determining logic module 142. The analog feedback signal at least includes: an analog signal that includes but is not limited to a level signal of each of the power supply modules, the feedback signal of the laser transmitter, the feedback signal of the receiver, the feedback signal of the temperature sensor, the feedback signal of the scanning module, and so on. The digital signal processing module 1442 may be, through a communication interface therein, connected to a communication interface corresponding to each of the plurality of functional modules and the state determining logic module 142, and may acquire and transmit the digital feedback signal inputted by each of the plurality of functional modules to the state determining logic module 142. The digital feedback signals may be transmitted between the digital signal processing module 1442 and each of the plurality of functional modules through communication protocols including IIC, SPI, UART and so on. The state determination module 140 may further include the state determining logic module 142. The state determining logic module 142 may be connected to the pre-storage module 120 and acquire the state information in the pre-storage module 120. The state determining logic module 142 may also be connected to the data acquiring module 144, and acquire the feedback signal of each of the plurality of functional modules that is acquired by the data acquiring module 144. The state determining logic module may further acquire the digital signals of the functional modules that are sent by the analog-to-digital converter 1441B, and may acquire the digital feedback signals of the functional modules that are sent by the digital signal processing module. The state determining logic module 142 may also be connected to the state and error type register module 180, and compare the digital signal or the digital feedback signal with the state information to obtain the comparison result. When the comparison result is consistency, the state determining logic module 142 determines that the operating state is the normal operating state. When the comparison result is inconsistency, the state determining logic module 142 determines that the operating state is the abnormal operating state and writes the corresponding operating state into the state and error type register module 180. When the operating state is the abnormal operating state, the state determining logic module may further write the error type corresponding to the abnormal operating state into the state and error type register module 180.

Specifically, the data acquiring module 144 further includes the temperature sensor 1443, and the temperature sensor 1443 is connected to the state determining logic module 142.

Specifically, under normal circumstances, in the laser radar, some modules have high power consumption and a large increase in a temperature, and some chips are temperature-sensitive chips. For example, the operating states of the laser transmitter and the receiver are affected by the temperature. Optical power of the laser transmitter is attenuated and a wavelength of the laser transmitter drifts at a high temperature. A breakdown voltage of the receiver changes with a change in the temperature, so the bias voltage on the receiver must be dynamically adjusted according to the change in the temperature. Based on the above reasons, the temperatures of main ones of the modules in the laser radar must be monitored and provided to the state control apparatus 100 for monitoring and adjusting the operating states of the main ones of the modules. The temperature sensor 1443 may be configured to monitor an ambient temperature in the laser radar, and the state determining logic module 142 reads the temperature information of the temperature sensor 1443 and accordingly determines whether the temperature in the laser radar is normal.

In this embodiment, the analog signal processing module 1441, the digital signal processing module 1442 and the temperature sensor 1443 are able to respectively acquire the feedback signals of different types of the functional modules in the laser radar and process the feedback signals of various types of the functional modules.

In one embodiment, the state control apparatus of the laser radar may be a monolithic integrated chip. The monolithic integrated chip may have the functions of the modules in the state control apparatus of the laser radar as mentioned in the above embodiments.

All or some of the above-mentioned modules in the state control apparatus 100 of the laser radar may be fully or partially implemented by software, hardware and a combination thereof. The above-mentioned modules may be embedded into or independent of a microprocessor in a hardware form, or stored in a storage of a laser radar apparatus in a software form, so that a processor executes the operations corresponding to the above-mentioned modules.

In one embodiment, the present disclosure further provides a laser radar, and the laser radar includes:
a plurality of functional modules; the plurality of functional modules at least include a laser transmitter, a plurality of power modules, a receiver, a scanning module and a sensor; and
the state control apparatus 100 of the laser radar in any one of the above embodiments.

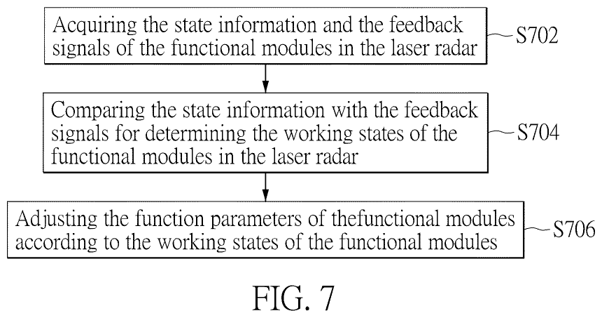

In one embodiment, the present disclosure further provides a control method for the laser radar, which is applied to the state control apparatus 100 of the laser radar or to the laser radar in any one of the above embodiments. As shown in FIG. 7, the control method or the laser radar includes:
S702, acquiring the state information and the feedback signals of the functional modules in the laser radar;
S704, comparing the state information with the feedback signals for determining the operating states of the plurality of functional modules in the laser radar;
S706, adjusting the function parameter of each of the functional modules according to the operating state of each of the plurality of functional modules, and the function parameter includes the high voltage value, the output optical power, the emission mode, the temperature control parameter, the scanning speed, the scanning phase or any combination thereof.

In one embodiment, the step of adjusting a function parameter of each of the plurality of functional modules according to the operating state of each of the plurality of functional modules includes:
when the operating state of each of the plurality of functional modules is the abnormal operating state, determining the error type corresponding to the abnormal operating state, determining the corresponding adjustment information and/or the corresponding enable control information according to the error type, and controlling each of the plurality of functional modules to adjust the function parameter according to the adjustment information or controlling each of the plurality of functional modules to stop operating according to the enable control information.

In one embodiment, after the functional parameter of each of the plurality of functional modules is adjusted according to the operating state of each of the plurality of functional modules, the method further includes:

outputting the enable control information and controlling each of the plurality of functional modules to stop operating according to the enable control information when the operating state of each of the plurality of functional modules adjusting the function parameter is still in the abnormal operating state.

In one embodiment, the method further includes: temporarily storing the operating state of each of the plurality of functional modules, and also temporarily storing the error type corresponding to the abnormal operating state when the operating state is the abnormal operating state.

In one embodiment, the step of comparing the state information with the feedback signal for determining the operating state of each of the plurality of functional modules in the laser radar includes:
comparing the feedback signal of each of the plurality of functional modules with the state information, determining that the operating state is the normal operating state when the feedback signal is consistent with the state information, and determining that the operating state is the abnormal operating state when the feedback signal is not consistent with the state information.

For the specific implementation and limitation of this embodiment can be found in the above embodiments, which are not repeated herein.

It should be understood that, although the steps involved in the above embodiments are sequentially indicated by the arrows in the flowcharts, but these steps are not necessarily executed sequentially in an order indicated by the arrows. Unless otherwise specified herein, the order in which these steps are performed is not strictly limited, and these steps may be performed in other orders. Furthermore, at least some of the steps in the flowcharts of the above embodiments may include a plurality of steps or stages. These steps or stages are not necessarily performed at the same time, but can be performed respectively at different time points. These steps or stages are not necessarily performed sequentially, but may be performed in rotation or alternation with other steps or at least some of steps or stages in the other steps.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A state control apparatus of a laser radar, the laser radar including a plurality of functional modules for maintaining an operation of the laser radar, the state control apparatus of the laser radar comprising:
a pre-storage module configured to store state information of the functional modules;
a state determination module connected to the pre-storage module, wherein the state determination module is configured to acquire feedback signals of the functional modules in real time, and compare the feedback signals of the functional modules with the state information for determining operating states of the functional modules in the laser radar; and
a state control module connected to the state determination module, wherein the state control module is configured to adjust a function parameter of each of the functional modules in the laser radar according to the operating states determined by the state determination module, and the function parameter includes a high voltage value, output optical power, an emission mode, a temperature control parameter, a scanning speed, a scanning phase or any combination thereof.

2. The state control apparatus of the laser radar according to claim 1, wherein, when the state determination module determines that the operating states of the functional modules are abnormal operating states, the state control module is further configured to determine error types corresponding to the abnormal operating states, determine adjustment information and/or enable control information according to the error types, and control the functional modules to adjust the function parameters according to the adjustment information or control the functional modules to stop operating according to the enable control information.

3. The state control apparatus of the laser radar according to claim 2, wherein, when the operating states of the functional modules are still the abnormal operating states after the functional modules adjust the functional parameters according to the adjustment information, the state control module is further configured to output the enable control information and control the functional modules to stop operating according to the enable control information.

4. The state control apparatus of the laser radar according to claim 2, wherein the state control apparatus of the laser radar further comprises:
a state and error type register module connected to the state determination module, configured to store the operating state of each of the functional modules, and configured to temporarily store the error type corresponding to the operating state when the operating state is the abnormal operating state.

5. The state control apparatus of the laser radar according to claim 4, wherein the state control module includes:
a feedback adjustment and fault control module connected to the state and error type register module, and configured to generate the adjustment information and/or the enable control information according to the operating states of the functional modules;
a digital signal output port connected to the feedback adjustment and fault control module and configured to output a digital signal including the adjustment information and the enable control information; and
an analog signal output port connected to the feedback adjustment and fault control module and configured to output an analog signal including the adjustment information.

6. The state control apparatus of the laser radar according to claim 5, wherein the state control apparatus of the laser radar further includes a communication interface, and the communication interface is connected to the pre-storage module, the state and error type register module and the feedback adjustment and fault control module;
wherein the feedback adjustment and fault control module is further configured to receive the adjustment information and/or the enable control information through the communication interface;
wherein the state and error type register module is further configured to output operating state information of the functional modules through the communication interface, and output the error types corresponding to the abnormal operating states when the functional modules are in the abnormal operating states.

7. The state control apparatus of the laser radar according to claim 4, wherein the state determination module includes an analog signal processing module, a digital signal processing module and a state determining logic module;
wherein the analog signal processing module includes an analog selector and an analog-to-digital converter; the analog selector is connected respectively to the functional modules and the analog-to-digital converter, and configured to acquire an analog feedback signal inputted by each of the functional modules and transmit the analog feedback signal to the analog-to-digital converter; the analog-to-digital converter is connected to the state determining logic module, and configured to convert the analog feedback signal into a digital signal and transmit the digital signal to the state determining logic module;
wherein the digital signal processing module is connected respectively to the functional modules and the state determination logic module, and configured to acquire a digital feedback signal inputted by each of the functional modules and transmit the digital feedback signal to the state determining logic module;
wherein the state determining logic module is connected respectively to the state and error type register module and the pre-storage module, configured to compare the digital signal and/or the digital feedback signal of each of the functional modules with the state information to obtain a comparison result, configured to determine that the operating state is a normal operating state when the comparison result is consistency, and configured to determine that the operating state is the abnormal operating state when the comparison result is inconsistency.

8. The state control apparatus of the laser radar according to claim 7, wherein the state determination module further includes a temperature sensor connected to the state determining logic module.

9. The state control apparatus of the laser radar according to claim 1, wherein the state control apparatus of the laser radar is a monolithic integrated chip.

10. A laser radar, comprising:
functional modules that at least include a laser transmitter, a plurality of power supply modules, a receiver, a heating module, a scanning module and a sensor in the laser radar; and
the state control apparatus of the laser radar according to claim 1.

11. A control method for a laser radar, wherein the control method for the laser radar is applied to the state control apparatus of the laser radar according to claim 1, the control method comprising:
acquiring a feedback signal and state information of each of the functional modules in the laser radar;
comparing the feedback signal with the state information of each of the functional modules for determining an operating state of each of the functional modules in the laser radar; and
adjusting a function parameter of each of the functional modules according to the operating state of each of the function modules, wherein the function parameter includes a high voltage value, output optical power, an emission mode, a temperature control parameter, a scanning speed, a scanning phase or any combination thereof.
